(19) United States
(12) Patent Application Publication
(10) Pub. No.: US 2007/0129949 A1
(43) Pub. Date: Jun. 7, 2007

(54) System and method for assisted speech recognition

(76) Inventors: William P. Alberth JR., Prairie Grove, IL (US); Ilya Gindentuller, San Diego, CA (US); John C. Johnson, Spring Grove, IL (US)

Correspondence Address: MOTOROLA INC, 600 NORTH US HIGHWAY 45, ROOM AS437, LIBERTYVILLE, IL, 60048-5343, US

(21) Appl. No.: 11/295,323

(22) Filed: Dec. 6, 2005

(51) Int. Cl. G10L 15/06

(52) U.S. Cl. 704/270.1

(57) ABSTRACT

Methods, systems and devices for a server remote to a mobile communication device are disclosed. The methods, systems, and devices process an audio sample of the mobile communication device and then provide a decoded audio sample to the mobile communication device. In one embodiment of a method of a server and a remote communication device, the method of the server includes receiving an audio sample from a remote communication device, applying a speech recognition algorithm to the audio sample to generate a decoded audio sample, generating the decoded audio sample and generating a training sequence to program the remote communication device to recognize another audio sample substantially similar to the audio sample.

### TECHNICAL FIELD

This disclosure relates to speech recognition, and more particularly to assisting speech recognition in a mobile communication device over a network.

### BACKGROUND OF THE INVENTION

Speech recognition in mobile communication devices is a relatively new feature. While the technology of mobile communication devices has advanced greatly, speech recognition abilities of a mobile communication device do not match that of, for example, a personal computer. A mobile communication device has a small processor comparatively, and also must conserve power since it is battery operated.

Mobile communication devices, especially mobile telephones, are trending toward smaller devices. Therefore, the keypads of the telephones are becoming smaller and more difficult for users to use to input data. For example, dialing a ten digit telephone number has become cumbersome. Also, text messaging is difficult on the small keys. Speech recognition for data input is beneficial in small phones in particular.

The benefits of speech recognition in mobile communication devices include hands-free dialing but go further. In certain states in the United States, for example, it is illegal to operate a telephone while driving. Were a user to use speech commands, instead of keying in commands according to prompts, a user could be less distracted and could be more able to concentrate on driving while placing and dialing a telephone call.

Hands-free operations are beneficial for many user interface applications. Furthermore, new user interface applications may become prevalent in mobile communications devices as a result of improved speech recognition. For example, speaker verification may become prevalent so that the device will not work but for the voice of an authorized user. Speaker verification can also block access to long distance calling or 800 numbers as well. In addition to dialing, speech recognition services may include application launching, such as for accessing contacts and calendars, but may also include web navigation, and speech-to-text for messaging and email. Greater memory may also drive a trend toward MP3 music capabilities, so that speech recognition may provide voice-activated search engines to help users find songs by name, genre or artist. Mobile researching databases might upon verbally providing the name of a street generate a map or directions from a GSP provided location.

Speech may become the primary interface in mobile communication device computing. Users may use keypads less and less. While much research and development may be working to improve the speech recognition capabilities of a small mobile communication device, problems in the technology persist. In certain speech recognition technology, both speaker dependent and speaker independent features are being used simultaneously. However, the computing power of the mobile communication device, and particularly with smaller and smaller cellular telephones, may be limited by processor speed and memory.

### BRIEF DESCRIPTION OF THE DRAWINGS

The accompanying figures, where like reference numerals refer to identical or functionlly similar elements throughout the separate views and which together with the detailed description below are incorporated in and form part of the specification, serve to further illustrate various embodiments and to explain various principles and advantages all in accordance with the present invention.

FIG. 1 shows an embodiment of a system disclosed herein of a mobile communication device and a server;

FIG. 2 is a flow chart of the system including the interaction of the mobile communication device and the server; and

FIG. 3 is a signal flow diagram between a mobile communication device and a server.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Disclosed herein are methods, systems and devices for a server remote to a mobile communication device to process an audio sample of the mobile communication device and then provide a decoded audio sample to the mobile communication device. In one embodiment of a method of a server and a remote communication device, the method of the server includes receiving an audio sample from a remote communication device, applying a speech recognition algorithm to the audio sample to generate a decoded audio sample, generating the decoded audio sample, and generating a training sequence to program the remote communication device to recognize another audio sample substantially similar to the audio sample.

An embodiment of a method of a communication device includes receiving an audio sample from a user, for example, attempting to recognize the audio sample, transmitting the audio sample to the remote server, receiving from the remote server a decoded audio sample and a training sequence based on the transmitted audio sample and processing the decoded audio sample. The system of the mobile communication device and the remote server provides that the server, having superior computing power, may resolve speech recognition inadequacies of the speech recognition application resident on the mobile communication device.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

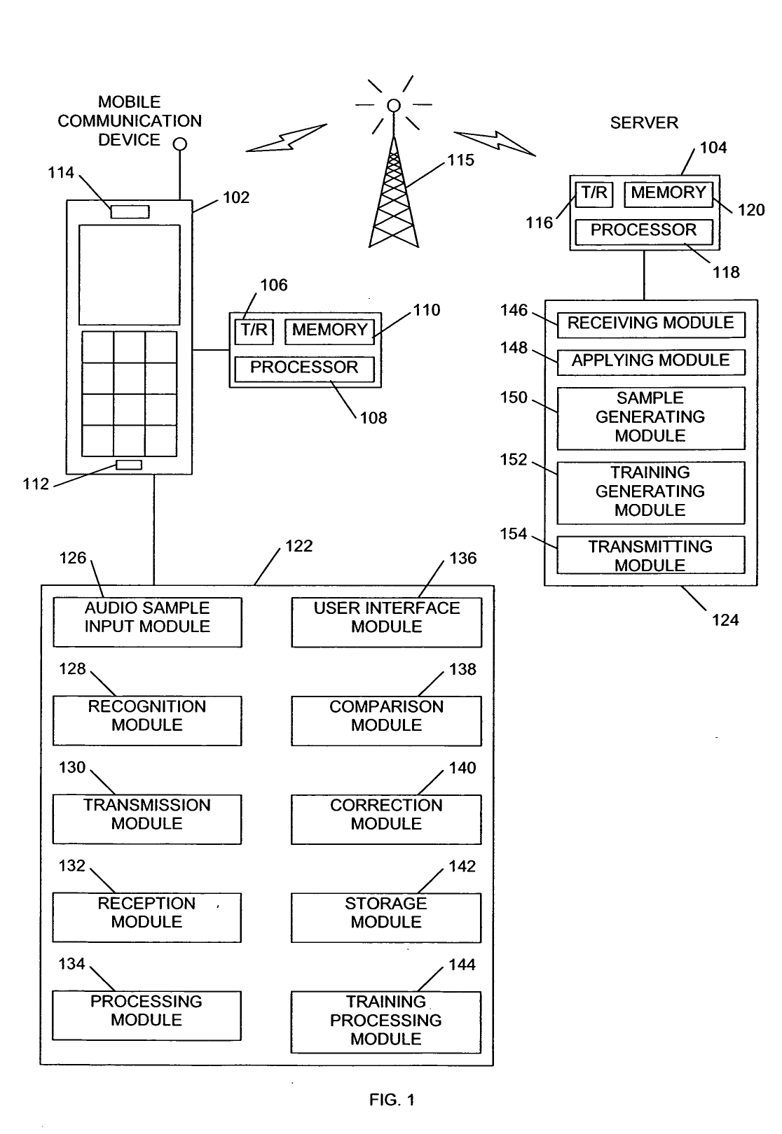

FIG. 1 shows an embodiment of a system disclosed herein of a mobile communication device and a server. An embodiment of a mobile communication device 102 herein depicted as a cellular telephone and an embodiment of a server 104 are shown as configured for communication with one another. A wide variety of communication devices that have been developed for use within various networks are included in this discussion. Handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, audio and music players and the like. It is understood that any mobile communication device is within the scope of this description. The mobile communication device depicted in FIG. 1 can include a transceiver 106, a processor 108 and a memory 110, audio input device 112 and audio output device 114.

The server is depicted as a remote server 104 in wireless communication via network 115. The network of course may be any type of network including an ad hoc network or a WIFI network. Likewise, the server may be of any configuration. The server may be one server or a plurality of servers in communication in any arrangement. The operations of the server may be distributed among different servers or devices that may communicate in any manner. It is understood that the depiction in FIG. 1 is for illustrative purposes. The server can include a transceiver 116, a processor 118 and a memory 120.

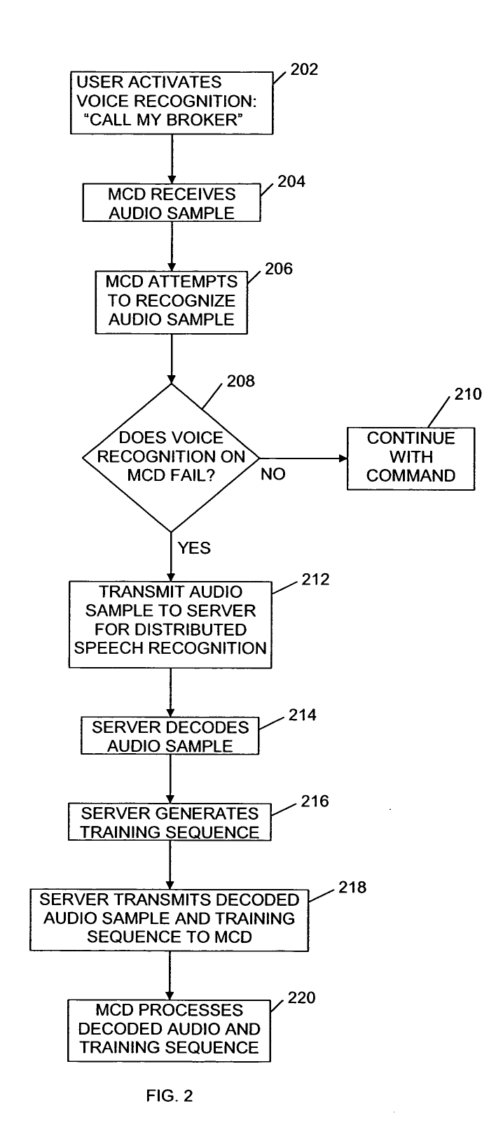

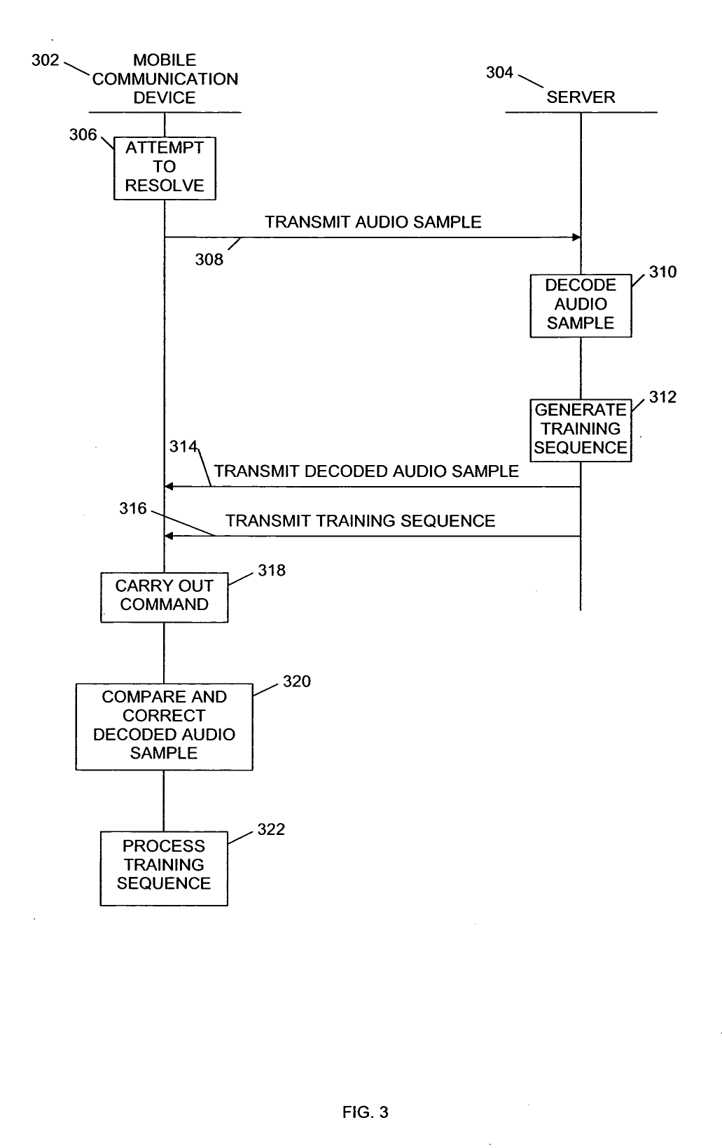

Both the device and the server may include instruction modules 122 and 124, respectively that may be hardware or software to carry out instructions. The operations of the modules will be described in more detail in reference to the flowchart of FIG. 2 and the signal flow diagram of FIG. 3. The mobile communication device modules can include an audio sample input module for receiving an audio sample to the communication device 126, an audio sample recognition module for attempting to recognize the audio sample 128, a transmission module for transmitting the audio sample to a remote server to generate a transmitted audio sample 130, a reception module for receiving from the remote server a decoded audio sample and training sequence based on the transmitted audio sample 132, and a processing module for processing the decoded audio sample 134. Also, the modules can include a user interface module for providing a user interface to facilitate a comparison 136 and a comparison module for comparing the decoded audio sample with the audio sample to generate a comparison 138. Also device modules can include a correction module for correcting the decoded audio sample based on the comparison 140, a storage module for storing the training sequence 142, and a processing module for processing the training sequence 144.

The server device can also include modules such as receiving module for receiving an audio sample from a remote communication device 146, a speech recognition algorithm applying module for applying a speech recognition algorithm to the audio sample to generate a decoded audio sample 148, a sample generating module for generating a decoded audio sample 150, a training generating module for generating a training sequence to program the remote communication device to recognize another audio sample substantially similar to the audio sample 152, and a transmitting module for transmitting both the decoded audio sample and the training sequence to the remote mobile communication device 154.

FIG. 2 is a flow chart of the system including the interaction of the mobile communication device and the server described above. A user or other entity can activate a speech recognition application on the mobile communication device 202. For example, the speech recognition application may respond to call commands such as “Call my broker.” The mobile communication device (MCD) receives the audio signal from the user 204. In the speech recognition application, the mobile communication device attempts to recognize the audio sample 206. In the event that the audio sample is recognized 208, the mobile communication device can process the command or audio sample 210. If the speech recognition on the mobile communication device fails 208, the audio sample is transmitted to the server for distributed speech recognition 212. In this manner, the speech recognition operations are distributed from the mobile communication device to the server.

The server includes a speech recognition application. As mentioned above, the server may be a single device, or a plurality of devices that are configured in any manner and that can communication in any manner. The speech recognition application of the server decodes the audio sample 214 and generates a training sequence 216 for the mobile communication device. The server transmits the decoded audio sample and the training sequence to the mobile communication device 218.

The mobile communication device can process 220 the decoded audio sample and the training sequence in many different manners. In one embodiment the mobile communication device can provide a user interface to the communication device to facilitate a comparison by comparing the decoded audio sample with the audio sample to generate a comparison. The decoded audio sample can be corrected based on the comparison.

A distributed speech recognition via a server as described above can be more comprehensive and accurate that that processed by the processor of a mobile communication device. However, if the distributed speech recognition is used solely by a mobile communication device, the traffic over the network 115 to and from a speech recognition engine remote to the mobile communication device may be cumbersome. Therefore, the combination of a server based application with a mobile based application can help avoid too much additional traffic. Accordingly, there are steps which may be taken by the mobile communication processor, for example, to attempt the speech recognition before transmitting the audio sample to the server. As discussed with respect to the mobile communication device modules listed above, an audio sample recognition module for attempting to recognize the audio sample may include any type of speech recognition application available. As the speech recognition applications for mobile communication devices become more powerful, the traffic with audio sample transmissions and their return decoded audio sample and training sequence will lessen. Furthermore, transmission requirements on a network can decrease as the local engine of the mobile communication device adapts to its user.

FIG. 3 is a signal flow diagram between a mobile communication device and a server. The mobile communication device 302 and the server 304 can be in communication. The mobile communication device can receive an audio sample from, for example, a user issuing a command to the device. The device can attempt to resolve the audio sample 306. Different methods of determining whether the audio sample is recognized may be used. For example, a probability function may be utilized for the determination. The speech recognition may be based on Hidden Markov Models or other speech recognition algorithms as are well known in the art.

If the attempt has failed or other predetermined criteria are met, the mobile communication device can transmit the audio sample to the server 308. Whether to transmit to the server can be a decision made by the user, based on a prompt on the mobile communication device display, for example. On the other hand, the transmission to the server can be transparent to the user. The communication device can be preset, for example, during manufacture or by the user to automatically transmit to the server an audio sample for which speech recognition failed.

The server, as discussed previously, can provide a more accurate recognition 310 and can also provide a training sequence to train the mobile communication device 312. The types of speech recognition that can be used by the server include Hidden Markov Models with large Dictionaries and other algorithms which require MIPS (millions of instructions per second) and memory that exceed those available on the mobile device. Different languages may require different types of speech recognition algorithms to be applied to an audio sample. It is understood that any and all types of speech recognition applications on the mobile communication device and the server are within the scope of this discussion. Moreover, the training sequence generated by the server can include a sequence of phonemes. This sequence, coupled with the audio sample and the decoded audio sample can be used to train new dictionary or phone book entries, or used to adapt more general speaker independent phoneme models. It is understood that any and all types of training sequence generator applications for use on a mobile communication device and by the server are within the scope of this discussion.

The server may then transmit one or more decoded audio samples to the mobile communication device 314. Additionally the server can transmit one or more training sequences 316. Transmissions 314 and 316 may be carried out in one transmission, or separately. The training sequence may be delayed due to, for example, traffic over the network 115 to and from the server.

Upon receipt of the decoded audio sample, a user may be provided an option to compare 320 the decoded audio sample with the original audio sample. Furthermore, the user can be given the option to correct the decoded audio sample. For example, the server may have incorrectly interpreted “send” as “end.” On the display device, by an audio signal or any other user interface, the user may indicate whether the user disagrees or agrees with the decoding. If the user disagrees with the decoding, the user can correct the decoded audio sample through a user interface.

The mobile communication device may process the training sequence 322. In the event that the processor doesn't have time to process the training sequence when it is received, the training sequence can be stored in a memory of the communication device or other memory device. In either event, that is, when received or after received, the processor can process the training sequence.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method of a server and a remote communication device, the method of the server comprising:
receiving an audio sample from a remote communication device;
applying a speech recognition algorithm to the audio sample to generate a decoded audio sample;
generating the decoded audio sample;
generating a training sequence; and
sending the training sequence to the remote communication device.

2. The method of claim 1 further comprising:
transmitting both the decoded audio sample and the training sequence to the remote communication device.

3. The method of claim 1, the method of the remote communication device further comprising:
receiving the audio sample; and
attempting to recognize the audio sample.

4. The method of claim 3, the method of the remote communication device further comprising:
transmitting the audio sample to the server.

5. The method of claim 4 of the remote communication device, further comprising:
receiving both the decoded audio sample and the training sequence from the server.

6. The method of claim 5 of the remote communication device, further comprising:
providing a user interface to facilitate a comparison;
comparing the decoded audio sample with the audio sample to generate a comparison.

7. The method of claim 6 of the remote communication device, further comprising:
correcting the decoded audio sample based on the comparison.

8. The method of claim 5, of the remote communication device, further comprising;
storing the training sequence.

9. The method of claim 5 of the remote communication device, further comprising;
processing the training sequence.

10. The method of claim 1 where the training sequence comprises of a series of phonemes.

11. A method of a communication device, comprising;
receiving an audio sample;
attempting to recognize the audio sample;
transmitting the audio sample to a remote server;
receiving from the remote server a decoded audio sample and a training sequence based on the transmitted audio sample; and
processing the decoded audio sample.

12. The method of claim 11, further comprising:
providing a user interface to the communication device to facilitate a comparison; and
comparing the decoded audio sample with the audio sample to generate a comparison.

13. The method of claim 12, further comprising:
correcting the decoded audio sample based on the comparison.

14. The method of claim 11, the method comprising;
storing the training sequence in a memory of the communication device.

15. The method of claim 11, the method comprising;
processing the training sequence by the communication device.

16. A communication device, comprising:
an audio sample input module for receiving an audio sample to the communication device;
an audio sample recognition module for attempting to recognize the audio sample;
a transmission module for transmitting the audio sample to a remote server to generate a transmitted audio sample;
a reception module for receiving from the remote server a decoded audio sample and training sequence based on the transmitted audio sample; and
a processing module for processing the decoded audio sample.

17. The communication device of claim 16, further comprising:
a user interface module for providing a user interface to facilitate a comparison; and
a comparison module for comparing the decoded audio sample with the audio sample to generate a comparison.

18. The communication device of claim 17, further comprising:
a correction module for correcting the decoded audio sample based on the comparison.

19. The communication device of claim 16, further comprising;
a storage module for storing the training sequence.

20. The communication device of claim 16, further comprising;
a processing module for processing the training sequence.

21. The communication device of claim 16, wherein the communication device is a cellular telephone.
